(19) United States
(12) Patent Application Publication
(10) Pub. No.: US 2013/0340387 A1
(43) Pub. Date: Dec. 26, 2013

(54) CAPSULE HOLDER FOR PREPARING A BEVERAGE

(71) Applicant: Alain Mariller, Le Mont-Pelerin (CH)

(72) Inventor: Alain Mariller, Le Mont-Pelerin (CH)

(73) Assignee: Ethical Coffee Company SA, Fribourg (CH)

(21) Appl. No.: 14/003,949

(22) PCT Filed: Mar. 7, 2012
(86) PCT No.: PCT/IB2012/051068

§ 371 Date: Sep. 9, 2013

(30) Foreign Application Priority Data
Mar. 7, 2011 (IB) PCT/IB2011/050955

(51) Int. Cl. A47J 31/40

(52) U.S. Cl. CPC A47J 31/407
USPC 53/381.1

(57) ABSTRACT

The capsule holder intended to be used with a capsule for preparing a beverage, for example coffee, comprises at least one receptacle for containing a capsule, said capsule holder being moved in relation to the capsule in order to move it into said receptacle by way of actuator means, said actuator means comprising weakening means that are able to limit the forces to which said actuator means can be subjected.

### FIELD OF THE INVENTION

The present invention falls within the field of the preparation of beverages, for example coffee-based, by extraction of a concentrated dose, for example of ground coffee, contained in a capsule. It relates to the doses used for this purpose and more particularly to the devices using such doses.

### PRIOR ART

Capsules and machines functioning according to the above-mentioned principle have existed for several decades.

The patents U.S. Pat. No. 2,899,886, U.S. Pat. No. 2,968,560, U.S. Pat. No. 3,403,617 and U.S. Pat. No. 3,607,297 describe devices in which the capsule is initially perforated in several places, then passed through by water under pressure.

The capsule described in the patent CH 605 293 or in the patent EP 0 242 556 B1 comprises a membrane in its lower part. Water under pressure is initially introduced in the upper part of the capsule, which brings about a swelling of the capsule, principally at the level of the membrane. Starting from a certain pressure, the membrane tears, thus permitting the flow of a water-coffee mixture.

Other capsules provided with a membrane are described in the following patent documents: EP 0 468 079 A, EP 0 806 373 A, EP 0 554 469 A.

### GENERAL DISCLOSURE OF THE INVENTION

One of the objectives of the present invention aims to optimize the “capsule—capsule holder” pair by proposing specific means, cooperating with one another, to obtain an optimum coupling of these elements and to thus improve the functioning of the machine.

In fact, in the field of these machines provision is generally made that the capsules are adapted for certain machines and that the machines only accept certain types of capsules which form the pair which is designated here “capsule—capsule holder”. Such a pair can be desired by the manufacturers of such products so as to ensure a certain quality thereof and also so as to limit the risks of problems if the user uses capsules and a machine (a capsule holder) which are not adapted to one another. In such a case one runs the risk of damaging these elements. If such a damage is negligible when it is the capsule which is affected, this is not the case if it is the machine (or a part thereof) which is damaged since it is the most expensive component.

For a manufacturer (especially for questions of guarantee), it is therefore important, on the one hand, to be able to determine if a non-adapted capsule has been used and, on the other hand, to provide means which prevent too great a “breakage” of the machine, even an injury to the user, if a non-adapted capsule is used.

These objectives are realized with the capsule holder as defined in the claims.

According to the invention, weakening means are provided, attached to the capsule holder, these means preventing in particular the putting in place of the capsule holder and, consequently, the functioning of the machine, when a non-adapted capsule is used.

These weakening means can be reversible, or not. More particularly, these means can be formed by zones which deform elastically or plastically when certain conditions are not realized, indicating that the capsule is not adapted to the capsule holder and to the machine.

The conditions to be realized can be various. For example, provision can be made that the capsule sinks or engages into the capsule holder (as is the case in the current coffee machines using this principle) and that during this engaging the capsule deforms to permit the correct placing in position of the capsule holder and to ensure tightness. This principle implies that the capsule comprises deformable parts or is in a deformable material under these conditions. A non-adapted capsule, which, for example, would not deform, would not permit the capsule holder to arrive in final position or would involve at least exerting a greater force than the normal force (i.e. the force to be supplied with an adapted capsule), which greater force could effectively not be provided owing to these deformable zones.

Several equivalent ways of forming the means according to the invention are possible, and the example embodiments in the present application are given by way of illustration. Of course, they must not be considered as restrictive, and variations are possible within the framework of the present application, in particular by the use of equivalent means.

For example, in addition to a deformation of the capsule, particular shapes or dimensions etc. can be provided, for example.

### DETAILED DISCLOSURE OF THE INVENTION

The invention is described in further detail below by means of examples illustrated by the following figures:

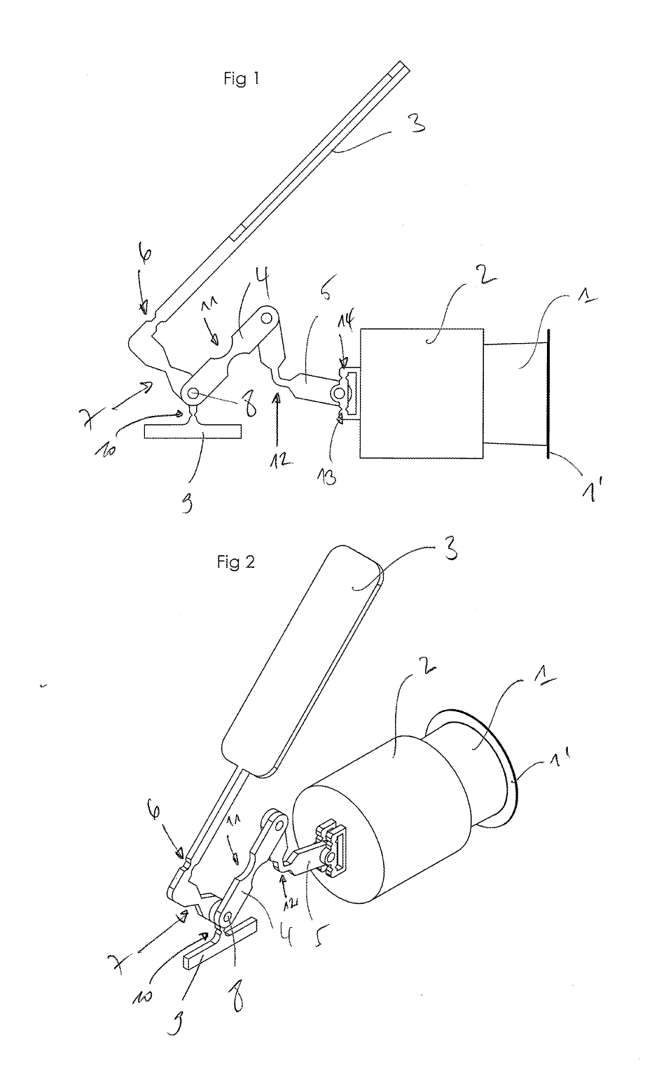

FIG. 1 presents a side view of an embodiment of a device and of a capsule according to the invention.

FIG. 2 presents a perspective view of the embodiment of FIG. 1.

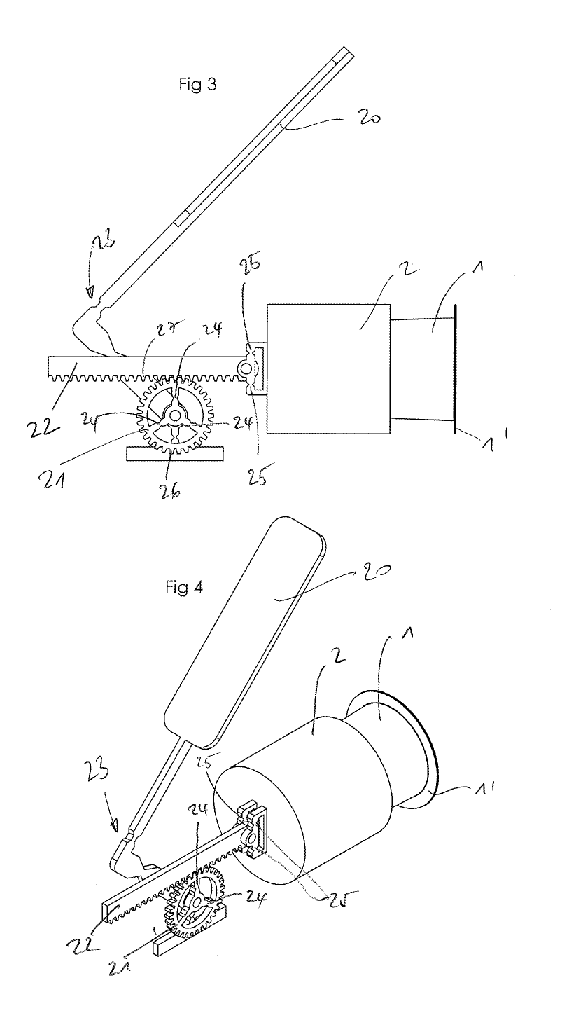

FIG. 3 presents a side view of an embodiment of a device and of a capsule according to the invention.

FIG. 4 presents a perspective view of the embodiment of FIG. 1.

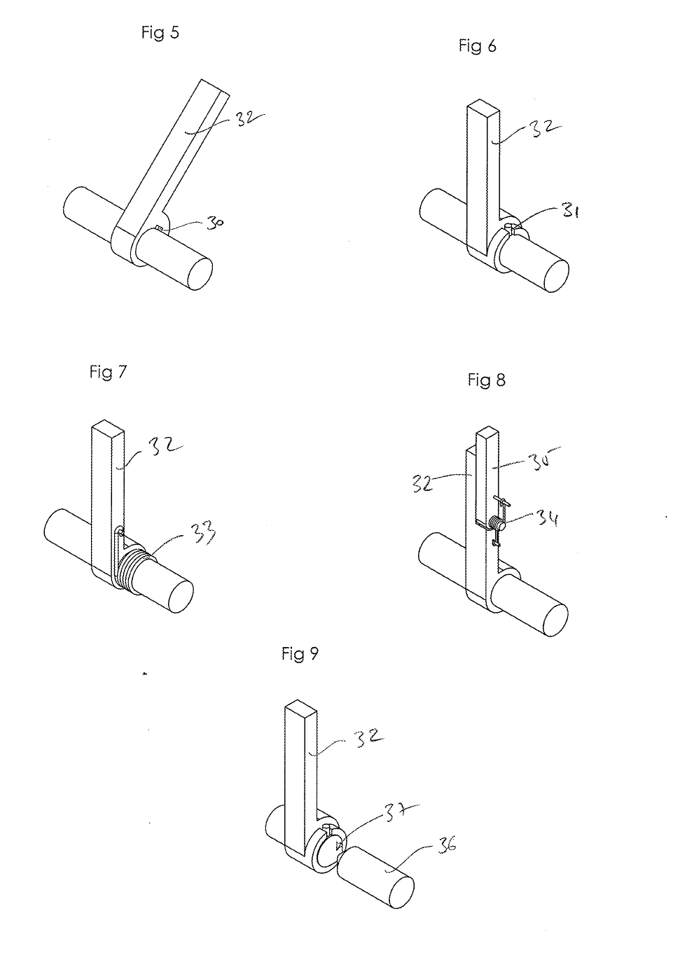

FIGS. 5 to 9 illustrate variants of means according to the invention.

In FIGS. 1 and 2, a capsule 1 (for example of coffee) has been represented diagrammatically, which is partially introduced in a capsule holder 2. In a known manner in the existing machines, the capsule holder 2 is generally moved in relation to the capsule 1 up to reaching the flange 1′ thereof, this relative movement having the effect of piercing the capsule by suitable means present in the capsule holder and of ensuring the tightness between the capsule 1 and the capsule holder 2.

So as to carry out the movement of the capsule holder 2, actuating means (generally manual) are used, which are manipulated by the user of the machine. Thus, once a capsule has been introduced into the machine, the user “closes” (even locks) the capsule holder by these actuating means, this operation having the effect (as indicated above) of forcing the capsule in the capsule holder and of piercing the capsule to permit the introduction therein of a liquid under pressure and to create the desired beverage, such as a coffee.

In the known systems, a certain manual force must be imparted by the user so that the capsule holder is in the final suitable position. According to the principles of the invention disclosed above, one seeks in particular to calibrate this force such that it must not exceed a certain value to prevent an inappropriate use of the system.

Consequently, the actuating means generally comprise one or more levers and bearing points. A configuration will be described below having several levers and bearing points, but it is evident that this is only an example and that there can be more or fewer thereof than the number represented in the figures and which are only a non-restrictive illustration of the principle of the invention.

Returning to FIG. 1, it is observed that the actuating means of the capsule holder comprise a first lever 3 which is that which is generally manipulated by the user. This first lever 3 drives a second lever 4 which is itself connected to a third lever 5 which drives the capsule holder 2 linearly.

As described below, the levers mentioned each comprise adapted deformable means. Thus, the first lever 3 comprises a first weakening zone 6 which is formed in its body, this zone permitting a deformation of the lever if it is subjected to a force which is too great in relation to the resistance of this zone 6 (taking into account the lever arm).

The end of the lever 3 comprises a second weakening zone 7 which functions according to the same principle as the zone 6.

The common axis 8 between the levers 3 and 4 is itself also connected to a bearing point 9 by a weakening zone 10. The levers 4 and 5 also have weakening zones 11, respectively 12, and finally the lever 5 is connected to the capsule holder 2, also by weakening zones 13, 14.

As will be readily understood, the presence of these weakening zones permits specific deformation, even rupture, sites to be provided, which will be implemented if the forces exerted on the system, in particular from the first lever 3 to bring the capsule holder into the appropriate position are greater than a specific value.

Of course, it is not indispensable to provide all the weakening zones illustrated in FIG. 1. Fewer (but one as a minimum) or more thereof can be used. The choice of the number of such zones permits the deformations to be modulated and also to be dimensioned.

The deformation of the weakening zone or zones can be elastic, plastic, or proceed to rupture, the combination of two or of the three being possible as a function of the number of weakening zones.

As is observed in FIG. 1, the weakening zone 12 is represented in a deformed state, indicating that the lever 3 has been actuated with a force greater than the resistance of this zone 12. This can typically, according to the present invention, originate from a blocking of the relative movement of the capsule holder 2 with respect to the capsule 1.

FIGS. 3 and 4 show another mode of execution in which the levers 4 and 5 are, in particular, replaced by a toothed wheel 21 and a rack 22. More precisely, the lever 20 drives the wheel 21 in rotation, which by its meshing with the rack 22 permits the capsule holder 2 to be moved longitudinally towards the capsule 1. In this mode of execution, weakening zones are to be found on the lever (zone 23), on the wheel (zones 24) and on the connection of the rack 22 to the capsule holder 2 (zones 25). As in the mode of execution of FIGS. 1 and 2, all these weakening zones can be provided, or fewer or more.

In this mode of execution, the weakening zones can also be formed by the teeth 26/27 of the wheel 21 and/or of the rack. As indicated above, the deformation of the said zones can be elastic, plastic, or by rupture, even a combination.

In FIGS. 5 to 9, several variants have been illustrated of means permitting weakening zones to be realized, which are reversible or not.

FIGS. 5 and 6 illustrate systems with key 30 and pin 31. If the lever 32 (for example) imparts a force greater than a predetermined value on these elements 30, 31, they will deform, even break.

FIGS. 7 and 8 show examples with springs 33, 34, FIG. 8 illustrating more precisely a lever in two parts 32, 35 which are linked by the spring 34. As discussed above and according to the principles of the present invention, these springs permit a coupling of limited resistance to be created between the parts and any stress greater than a predetermined value will have as a consequence a relative movement of the parts which are thus linked, which will prevent a correct functioning of the machine.

In FIG. 9, a variant is illustrated using an axis 36 with a cone 37, this cone forming the weakening zone.

As will be understood from the different non-restrictive examples described above, the weakening means can take numerous different forms and can be situated on numerous sites of the machine, the aim being to prevent an inappropriate functioning of the machine according to the principles set forth above.

For example, the weakening means can be a zone or zones of reduced dimensions in relation to the remainder of the part on which it (they) is (are) placed. These zones can also be added on and/or formed of a different material. One can also make use of specific mechanical elements (see FIGS. 5 to 9).

### NUMERICAL REFERENCES USED IN THE FIGURES

1. capsule
2. capsule holder
3. first lever
4. second lever
5. third lever
6. weakening zone
7. weakening zone
8. axis
9. bearing point
10. weakening zone
11. weakening zone
12. weakening zone
13. weakening zone
14. weakening zone
15.
16.
17.
18.
19.
20. first lever
21. toothed wheel
22. rack
23. weakening zone
24. weakening zone
25. weakening zone
26. tooth of toothed wheel
27. tooth of rack
28.
29.
30. pin
31. key
32. lever
33. spring
34. spring
35. lever part
36. axis
37. cone of axis

1. A capsule holder intended to be used with a capsule for preparing a beverage, for example coffee, comprising at least one receptacle for containing a capsule, said capsule holder being moved in relation to the capsule in order to move it into said receptacle by way of actuator means, said actuator means comprising weakening means that are able to limit the forces to which said actuator means can be subjected.

2. The capsule holder according to claim 1, which the weakening zones are present on one or more parts of the actuator means.

3. The capsule holder according to claim 1, in which the weakening zones are deformable.

4. The capsule holder according to claim 3, in which the deformation is elastic.

5. The capsule holder according to claim 4, in which the deformation is plastic.

6. The capsule holder according to claim 4, in which the deformation is a rupture.

7. The capsule holder according to claim 1, in which the weakening zones are integrated in the actuator means.

8. The capsule holder according to claim 1, in which the weakening zones are added or appended or fixed on the actuator means.

9. A device comprising at least one capsule holder according to claim 1 and a capsule.
